(19) United States
(12) Patent Application Publication
(10) Pub. No.: US 2012/0117558 A1
(43) Pub. Date: May 10, 2012

(54) MOBILE APPLICATION MIGRATION SERVICE

(75) Inventors: Joseph Futty, Sammamish, WA (US); Matthew Graham Dyor, Bellevue, WA (US); Danny Lange, Sammamish, WA (US); Miller T. Abel, Mercer Island, WA (US)

(73) Assignee: Microsoft Corporation, Redmond, WA (US)

(21) Appl. No.: 12/939,429

(22) Filed: Nov. 4, 2010

(51) Int. Cl. G06F 9/445

(52) U.S. Cl. 717/176

(57) ABSTRACT

A mobile application migration service is usable to receive recommendations for replacement and/or alternative mobile applications for potential mobile device upgrades. Additionally, the service may be usable to compare legacy mobile applications to potential target mobile applications and simulate operation of selected target applications on a new target device. Further, a service may be usable to provide one-click purchase of one or more target applications, one-click installation of the selected target applications, and/or one-click migration of associated user and/or application data from a legacy device to a new device. Such recommendations, comparisons, simulations, and one-click migrations may be used to facilitate migration from one mobile device to another, even when legacy devices are customized with highly useful and/or often used applications.

### BACKGROUND

When mobile communication devices first became available to the general public they had very limited functionality. For example, the first devices merely transmitted text or voice signals. However, as technology has advanced, such devices have followed suit. Additionally, and somewhat in parallel, the number of mobile device applications has been rapidly growing since the inception of the first personal digital assistant (PDA). For example, at first, PDAs were simply used to manage contacts, to-do lists, and calendars; however, eventually they grew to provide nearly unlimited functionality as the number of applications grew.

Today, modern mobile devices, including cell phones, resemble advanced PDAs with voice, text, and/or data transmissions, as well as numerous applications for doing just about anything one could imagine. Thus, in today's world of ever-increasing mobility, it is no surprise that there are literally hundreds of thousands of mobile device applications. For example, a single mobile device may often times have more than fifty different applications which take money and time to install, and which also inherently add value.

As such, owners of mobile device who have invested considerable time and money into customizing their devices may be less willing to upgrade or switch to a different device and/or service provider, even when technologically superior devices are available. For example, if a user has purchased fifty or so applications they may be reluctant to switch devices due to the perceived hassle of re-customizing the new device. Unfortunately, current systems are not equipped to help users upgrade from one customized mobile device to another, especially when the customizations include a large number of mobile applications.

### BRIEF SUMMARY

This summary is provided to introduce simplified concepts for a mobile application migration service, which is further described below in the Detailed Description. This summary is not intended to identify essential features of the claimed subject matter, nor is it intended for use in determining the scope of the claimed subject matter. Generally, the mobile application migration service described herein involves using a central location to recommend and compare new mobile applications for a new mobile device to an existing mobile device user.

In one embodiment, a mobile application migration service may receive information about one or more mobile applications installed on a user's device (hereinafter, “legacy applications”). The service may then provide information about the availability of the legacy applications on a new mobile device or recommendations for alternative and/or replacement applications that are compatible with the new mobile devices, and may provide a comparison matrix for review by the user. Additionally, the user may be able to simulate the experience of the new device via a virtual machine environment. If a user decides to acquire the new device, the service may be configured to migrate the user's data, install one or all of the equivalent, alternative, and/or replacement applications on the new device, and/or send a notification to the user when applications that the user requests become available.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an illustrative system for implementing a mobile application migration service.

FIG. 2 is a schematic diagram illustrating details of an illustrative system for implementing a mobile application migration service.

FIG. 3 is flowchart illustrating details of a method for implementing a mobile application migration service.

FIG. 4 is a block diagram of a computer environment showing an illustrative system in which a mobile application migration service may be implemented.

### DETAILED DESCRIPTION

### Overview

This disclosure is directed, in part, to techniques for implementing a mobile application migration service. This disclosure is also related to providing a simple interface for mobile device users to upgrade, or change, mobile devices without manually searching, downloading, and installing mobile applications, and potentially also without manually transferring application data. Additionally, this disclosure describes an interface for comparing legacy applications with equivalent, alternative, or replacement applications. As such, the techniques may allow a mobile device user to effortlessly create a user experience on a new device much like that of their current device (hereinafter, “legacy device”). For instance, a mobile application migration service may help a user compare legacy applications to alternative applications that are configured for newer devices. This may help a user overcome their reluctance to switch from a first device/platform (e.g., an HTC® device running the Android™ operating system) to a second device/platform (e.g., a Samsung® device running the Windows® Phone operating system). During the comparison, the service may present recommendations to the user based on user reviews of the new applications, usage information regarding the legacy applications, information uploaded by an independent software vendor (hereinafter, “ISV”), and/or information regarding new features not available on the legacy device.

In one instance, a user may be presented with an offer to purchase a new mobile device. However, the user may have previously installed a large number of applications, which are used regularly, and which might be time-consuming and expensive to re-acquire on the new mobile device. Additionally, the new mobile device may use a different operating system than the legacy device and, as such, the applications on the legacy device may not be compatible with the new device. Moreover, some of the legacy applications may not even be available for the new device.

In this instance, the mobile application migration service may provide the user an interface for determining which legacy applications are available on the device (i.e., equivalents), whether replacement applications exist for the new device, what alternative applications may be available, what others have said about the replacement and/or alternative applications, and the importance, usage, size, and cost information for each application. Additionally, the service may provide a virtual machine environment for simulating the new equivalent, replacement, and/or alternative applications on the new device. In this way, the user can make a more informed decision about the potential purchase based on virtually testing the applications on the new device.

Additionally, in some instances, the migration service may offer free or discounted acquisition of applications that were previously installed on a user's legacy device. In this case, ISVs may even provide credits to the migration service to defray the cost of providing the free or discounted applications. Additionally, or in the alternative, the ISVs may provide free or discounted licenses to user's who had previously purchased a license for the same or similar application on their legacy device. These free or discounted licenses may be provided by the migration service on the behalf of the ISVs. In some cases, particular ISVs may attempt to incentivize the migration service to promote their particular applications by offering package deals, bulk sales, free downloads, or other types of discounts.

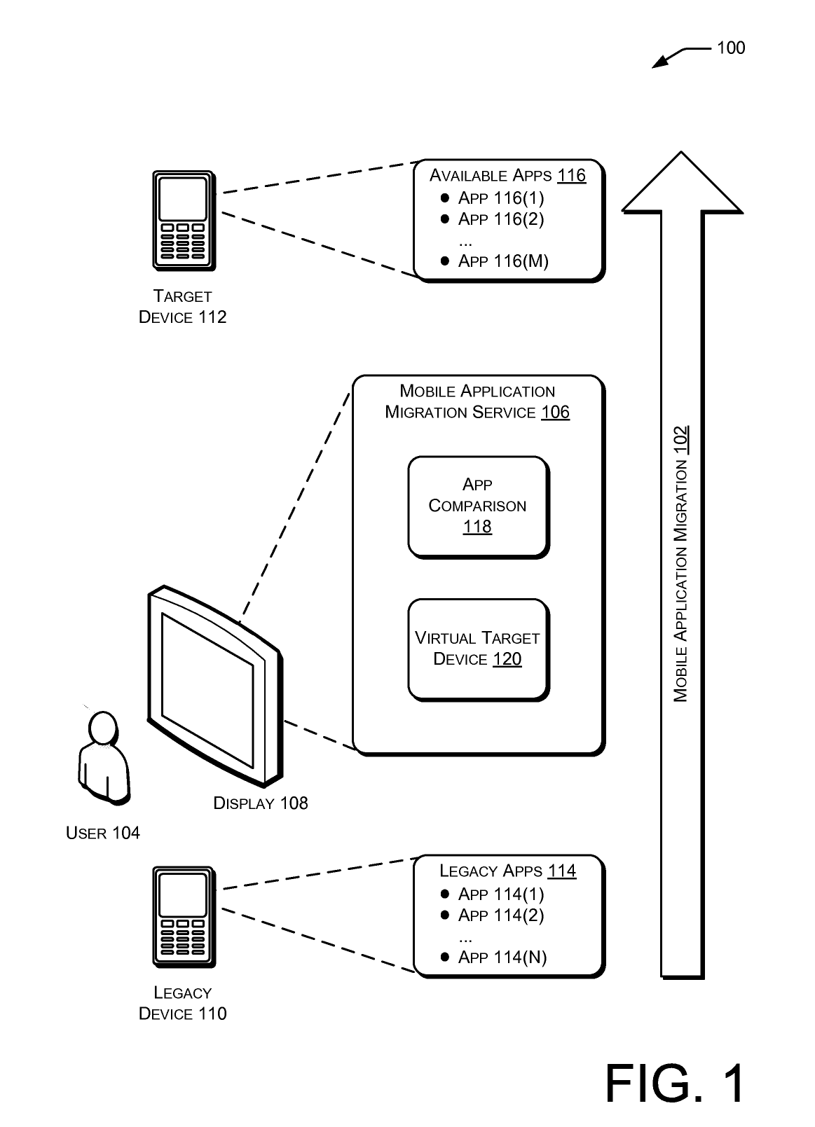

FIG. 1 depicts an illustrative example 100 of mobile application migration 102. By way of example only, a user 104 may interact with a mobile application migration service 106 via a display device 108 for migrating from legacy device 110 to a target device 112. In one example, the display device 108 may be the display of the legacy device 110 or it may be the display of another computing device. In at least one instance, when the display 108 is the display of another computing device, the legacy device 110 may be communicatively coupled, either wired or wirelessly, to that other computing device. However, in other examples, the legacy device 110 may not be connected to anything at all, or it may be connected to a wired or wireless network independent of other computing devices. Additionally, is some aspects, the migration service 106 may configured to access a user's accounts (e.g., a mobile application account such as iTunes®) rather than accessing the legacy device 110 at all.

In one aspect, the legacy device 110 may have installed thereon one or more legacy applications 114(1), 114(2), through 114(N), where N is an integer greater than zero. Legacy applications 114(1) through 114(N), (collectively “legacy applications 114”), may be currently installed applications on legacy device 110 that user 104 purchased or downloaded for free. The user 104 may use some legacy applications 114 more than others and/or may place more importance on some legacy applications 114 than others. As will be discussed in further detail below, the usage and/or importance information about each legacy application 114 may play a factor in recommending new applications to the user 104 and/or selecting new applications by the user 104.

Additionally, in one aspect, the user 104 may be presented with a hyperlink, a Web advertisement, or some other means of attracting or sending the user 104, possibly via a Web browser, to the mobile application migration service 106. In other aspects, however, the mobile application migration service 106 may be implemented in software and downloaded and/or installed on the legacy device 110, another mobile device, or some other computing device. Once interacting with the service 106, possibly via display 108, the user 104 may be presented with several options for upgrading to new or different mobile devices. One of such several possible options for upgrading is shown in FIG. 1 as target device 112. Target device 112 may be the only upgrade option presented to user 104. However, in other aspects, target device 112 may be the upgrade option that the user 104 has selected from several possible options.

In one aspect, target device 112 may be able to install and operate one or more available applications 116(1), 116(2), through 116(M), where M is an integer greater than zero. Available applications 116(1) through 116(M), (collectively “available applications 116”), may be applications that are currently installed on target device 112, such as pre-installed content, or may be applications that are available to be installed on the target device 112. In other words, available applications 116 may be applications that are compatible with the particular operating system run by target device 112, including both native applications and applications developed by ISVs. Native applications may be those provided by a device manufacturer or platform/operating system developer or may be those that are intended for use with a particular device or run on a particular operating system. Native applications may come preinstalled on the new device or may be purchased or downloaded separately. In some aspects, the available applications 116 may be equivalent, alternate, or replacement applications for legacy applications 114. That is, an equivalent application may be one that is created by the same provider as the legacy application 114 and is intended to be used as a direct migration from one device to the next. While these applications are discussed as equivalents, however, it should be understood that an equivalent application may in fact be a different version of the same legacy application and may not technically be equivalent (e.g., Tetris® for iOS 4.0® may be considered an equivalent for Tetris® for iPhone OS 3.0® even though the code may be completely different). On the other hand, an alternate application may be one that is recommended to be used over the legacy application 114, even when an equivalent application is available. Alternatively, a replacement application may be one that is intended to replace the legacy application 114 when an equivalent application is not available or when it is available but not feasible.

As discussed in detail below, in one aspect, the mobile application migration service 106 may include an application comparison feature 118 and a virtual target device feature 120. By way of example only, the user 104 may utilize the application comparison feature 118 and the virtual target device feature 120 to aid in deciding whether to migrate 102 from the legacy device 110 to the target device 112. Additionally, the features 118 and 120 may help the user 104 choose a target device 112 from a list of possible upgrade devices. More specifically, the application comparison feature 118 may provide recommendations to the user 104 about equivalent, replacement, and/or alternative applications that may be available for the target device 112.

Additionally, in one aspect, the application comparison feature 118 may provide a comparison matrix to the user 104. The comparison matrix may be a sortable grid for displaying legacy applications 114 alongside potential replacement and/or alternative applications for one or more target devices such as target device 112. In one aspect, the comparison matrix may be a compilation of several matrices, providing separate data for each, or subset of all, of the potential target devices 112 offered by the provider of the matrix. In other aspects, however, the comparison matrix may only provide application comparison data for a single target device 112. Additionally, and by way of example only, the comparison matrix may provide the ability for the user 104 to select which legacy applications 114 they wish to research. In one aspect, the matrix may contain usage information for each legacy application 114 so that the user 104 may see how often they use each of their legacy applications 114. Additionally, the user 104 may be able to select which legacy applications 114 they are interested in migrating and/or rank their legacy applications 114 by importance. In some examples, the matrix may also provide recommendations for equivalent, replacement, and/or alternative applications, user reviews of available applications 116, functional capabilities of the available applications with relation to the hardware of the target device 112, prices and licensing options for the available applications 116, and/or detailed information about the available applications 116 provided by the ISVs or other users.

Further, the user 104 may utilize the virtual target device feature 120 to further enhance the research and decision processes. In one aspect, the virtual target device feature 120 may provide a simulation of some or all of the available applications 116 running on the selected target device 112. In some examples, this may provide the user 104 with the ability to test out the look and feel of the available applications 116 to determine whether they are interested in migrating devices. By way of example only, the virtual target device feature 120 may be configured to simulate the available applications 116 on a display 108 of the target device 112, the legacy device 110, or some other computing device. As such, it may be possible for the user 104 to test out each of the available applications 116 as if they were actually using them on the target device 112.

In one instance, the virtual target device feature 120 may provide simulation of mobile applications on target devices 112 by providing an emulator that can simulate each potential target device 112. In one example, a single emulator may be configured to simulate different devices by displaying different device/platform combinations (e.g., Motorola Droid X® running Android 2.1 by Android™, or Palm Pre® running WebOS®) to the user 104. However, in other examples, the virtual target device feature 120 may use a different emulator for each device/platform combination.

FIG. 1 provides a simplified example of a suitable example 100 for implementing a mobile application migration service according to the present disclosure. However, other configurations are also possible. For example, and as described above, multiple different target devices 112 may be researched simultaneously, or sequentially, such that a user 104 may be aided in deciding whether to migrate to a new device.

### Illustrative Architectures

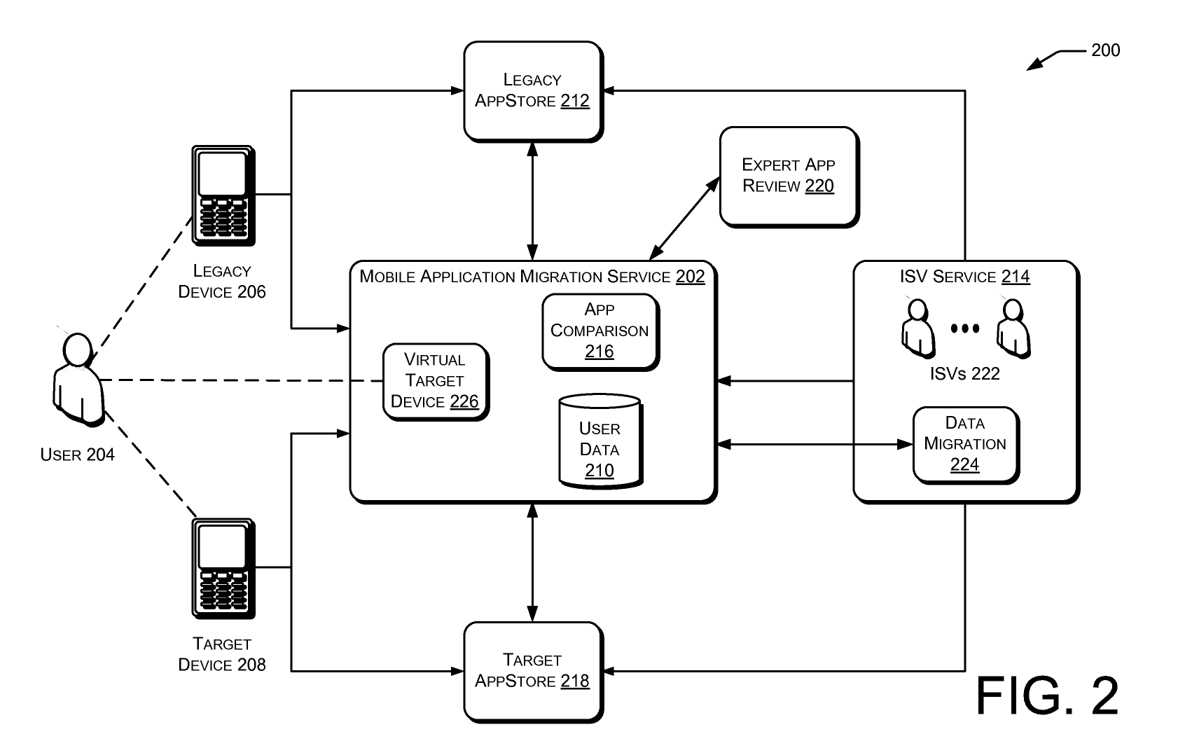

FIG. 2 depicts an illustrative system 200 for implementing a mobile application migration service 202 similar to service 106 of FIG. 1. In one aspect, a user 204 may interact with the mobile application migration service 202 to potentially migrate from a legacy device 206 to a target device 208. As such, the mobile application migration service 202 may aid the user 204 in deciding whether to acquire the target device 208. Additionally, the service 202 may further aid in the actual migration by installing some or all of the new applications on the target device 208 and/or transferring user data (that may be stored in the user data database 210) from the legacy device 206 to the target device 208. In one aspect, the service 202 operates as an in-cloud service that can handle each of the features described below remotely. Additionally, the service 202 may be configured to install new applications and transfer a user's data to a new device prior to the user taking possession of the new device.

In one example, the user 204 may currently use legacy device 206 as a cellular phone or other mobile communication device. Additionally, the legacy device 206 may contain one or more legacy applications that were purchased and/or downloaded from Legacy AppStore 212. Legacy AppStore 212 may be run by an ISV service 214, an application service, a cellular service provider, any combination thereof, or the like. In one instance, the Legacy AppStore 212 may contain data identifying which legacy applications are stored on the legacy device 206.

By way of example only, the mobile application migration service 202 may acquire data about which legacy applications are installed on the legacy device 206, and which legacy applications the user 204 wishes to migrate, in several different ways. In one example, the service 202 may allow the user 204 to manually enter a list of legacy applications and/or a list of legacy applications that the user 204 wishes to migrate. In another example, the service 202 may query the Legacy AppStore 212 for the list. As such, the service 202 may request that the user 204 provide their Legacy AppStore 212 user identifier and password. In yet another example, the legacy device 206 may be instrumented in such a way that it can enumerate the list of installed legacy applications and transmit the list, along with the list of applications selected for migration, to the service 202 via a network such as a cellular service or the Internet. This collection of installed legacy applications, and selected legacy applications, may additionally be stored in the user data database 210 or in some other portion of memory utilized by service 202. In addition, any combination of the above methods for acquiring the collection of installed and/or selected legacy applications may be employed.

Additionally, Legacy AppStore 212 may receive usage data about the legacy applications that are installed on the legacy device 206 directly from the legacy device 206 itself, as seen by the arrow pointing from legacy device 206 to Legacy AppStore 212. In one aspect, the user data database 210 of the mobile application migration service 202 may contain this usage information as well. By way of example only, usage information may be related to the frequency with which an application is used, the amount of time spent using the application, a percentage of time spent using the application with regard to total time spent using the device, time spent using all applications, or some other factor. Additionally, the mobile application migration service 202 may acquire the usage information in the same ways that were mentioned above with respect to the collection of installed legacy applications in order to understand the application scenarios.

As discussed above with respect to FIG. 1, a user 204 may interact with an application comparison feature 216 of the mobile application migration service 202 to help decide whether to upgrade to a new mobile device. In one aspect, the application comparison feature 216 may provide a comparison matrix to the user 204 for this purpose. By way of example only, the comparison matrix may provide recommendations for equivalent, replacement, and/or alternative applications that can be installed on target device 208. In one aspect, the recommendations may be based on available applications that are listed in a Target AppStore 218 associated with the target device 208. The Target AppStore 218 may provide the collection of all available applications, i.e., applications that are compatible with target device 208. Alternatively, or in addition, the target device 208 may provide the collection of available applications. From this collection of available applications, the service 202 may provide recommendations to the user 204 via the comparison matrix of the application comparison feature 216.

That is, the collection of all available target applications may provide more applications than are helpful to the user 204. Therefore a subset of all available target applications may be presented as recommendations to the user 204 based on several factors and/or additional data. In one aspect, information about the user 204 and the legacy applications may be used to make the recommendation. For example, the recommendation may be based on what types of legacy applications the user has installed on the legacy device 206 or how often the user 204 uses each legacy application.

Additionally, an expert application review service, or provider, 220 may provide expert reviews to the mobile application migration service 202. Based on these expert reviews, the mobile application migration service may be able to rank the available target applications and provide a collection of the best rated applications that are relevant. Further, the service 202 may provide a comparison of user reviews for the legacy applications that have been selected for migration. The reviews may be filtered to provide only reviews from users that have migrated from the same legacy application as the user to the same new device as the user. In this way, the service 202 may be able to aggregate reviews related to each device to determine whether the experience on the target device 208 will be better or worse than on the legacy device 206 for each selected application. Additionally, the service 202 may be able to weight each target application based on how often the respective legacy application for which it is a replacement and/or alternative is used. For example, a legacy application that is rarely used but has excellent functionality on the target device 208 may have a lower weight than a target application with poor functionality on the target device 208 where the user 204 regularly uses its equivalent.

In one aspect, the application comparison feature 216 may also provide, via a comparison matrix for example, upgrade information provided by one or more ISVs 222. ISVs 222 may provide this upgrade information via ISV service 214, or independently. By way of example only, an ISV 222 may provide upgrade information related to functionality of the target application on the target device 208, relatedness of the target application to other legacy applications (i.e., whether the target would make a good replacement or alternative), or discounted licensing opportunities for migrating and continuing (or beginning) to use the target application. As noted above, this data may be presented to the user 204 through the comparison application feature 216 and may also be part of the comparison matrix. The comparison matrix may also present new capabilities of the target applications on the target device 208 (e.g., the target application may have a hologram feature; however, only the target device 208 contains a hologram display).

Additionally, the ISV service 214 may aid in data migration 224 between the legacy device 206, the mobile application migration service 202, and the target device 208. That is, the ISV service 214 may share user and/or application data with the service 202. In one aspect, however, data may be migrated via a cloud service separate from the ISV service 214. Yet, in another aspect, the ISV service 214 may operate in conjunction with a cloud service for data migration 224. In one example, where the ISV service 214 shares user and/or application data, the ISV service 214 and/or the migration service 202 will provide opt-in and/or opt-out functionality. Additionally, in one instance, prior to any user information being collected and/or shared amongst the services, the user whose information is to be collected will be notified and given the option to opt-out prior to any data collection. Further, in one aspect, enhanced security measures will be employed in order to protect the user and/or application data.

As noted above with respect to FIG. 1, the mobile application migration service 202 may implement a virtual target device machine 226 (hereinafter, “VM”) to aid the user 204 in deciding whether to migrate and, if so, to which target device 208. In one aspect, the VM 226 may operate as an in-cloud emulator. The VM 226 may simulate the target application(s) by using migrated user and/or application data such that the user 204 can test out the operation of the target device 208 without first acquiring it. As such, the user 204 may run the target application(s) in a personalized mode to see that their personal data was properly migrated. Additionally, the VM 226 may provide migration reviews that are specific to the migration of target applications, rather than specific to the target application. In other words, if certain target applications have problems after migration or are unable to migrate all the user data, the user 204 may be able to find out prior to agreeing to migrate. Additionally, in some aspect, the user 204 may be able to try out the post-migration target device 208 for some limited period of time for free or for some nominal fee. Additionally, in one instance, the emulated experience may be copied directly to the target device 208 (e.g., by a disk image) such that the user 204 may customize the target device 208 on the emulator and make device settings that can be immediately implemented on the target device 208 without re-setting-up the target device 208.

Further, the mobile application migration service 202 may provide a one-click installation service to a user 204 that decides to acquire the upgrade. In one aspect, the user 204 may be able to select the one-click installation and purchase the target device 208 as well as each target application that requires a fee in one step. Additionally, the one-step installation service may be configured to install each of the target applications selected by the user 204 and/or other applications that were recommended including equivalents, replacements, and/or alternatives. Moreover, this service may provide a single check-out and payment feature for the migration service 202 such that the user 204 need not interact with multiple parties even if the migration collection contains target applications from different providers or ISVs 222. In some instances, device/platform providers (e.g., iPhone 4®/iOS 4.0®) may enter agreements with ISVs to waive fees or charge reduced fees for applications that were previously purchased for another device (e.g., iPhone 3G®/iPhone OS 2.0®) or for a device of a different platform (e.g., when a user goes from an iPhone 3G® device to any Windows® Phone device).

Alternatively, if the user 204 decides not to migrate, the mobile application migration service 202 may save the comparison data for later and send periodic reminders to the user 204 about upgrading. In one example, the service 202 may send a reminder when the target application ranked the highest, or used the most, by the user 204 becomes available on any new device. In another example, the reminder may be sent when a replacement is created for a particular legacy application requested by the user 204. Additionally, reminder frequency and relation may be set by the user 204, or the user may opt-out of reminders altogether.

### Illustrative Mobile Application Migration Service Processes

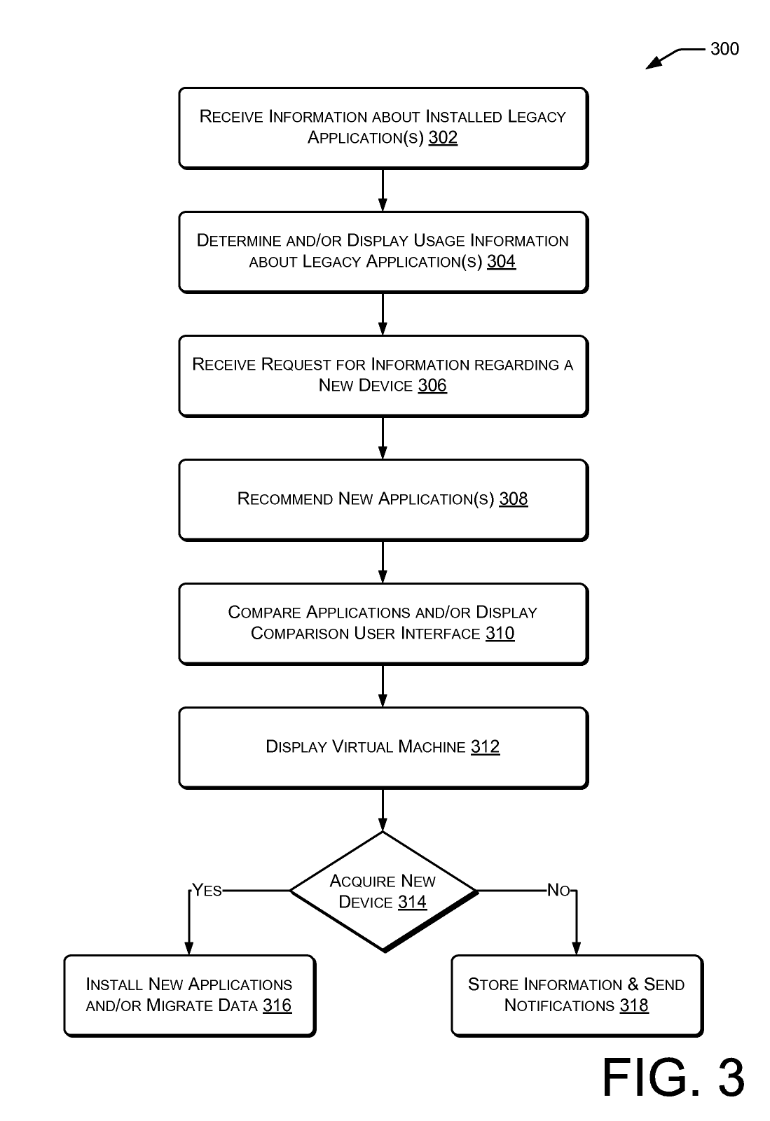

FIG. 3 is a flow diagram of one illustrative process 300 for implementing a mobile application migration service as described with reference to FIGS. 1 and 2. This process is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

FIG. 3 illustrates an example flow diagram of process 300 for implementing a mobile application migration service that may be responsible for interacting with a user to help them compare mobile applications and to ease the process of migrating from one device to another, as discussed above.

In this particular implementation, the process 300 may begin at block 302 of FIG. 3 in which the process 300 may receive information about one or more legacy applications that are installed on a legacy device. These legacy applications may have been purchased by a user, pre-installed on the legacy device, or downloaded for free over the course of operation of the legacy device. At block 304, the process 300 may determine and/or display usage information about the legacy applications. Determining the usage information may include querying the device, the user, or associated application stores. As noted above, in one example, users will be notified of any data collection and will be given the opportunity to opt-out of prior to any data being collected. Additionally, in one example, user data will be stored securely. Displaying the usage information may be important to help the user determine which applications are important enough to migrate. As such, this may encourage the user to reevaluate their mobile application needs and may lead to new application purchases.

The process 300 may receive a request for information regarding a new device at block 306. The request may be in response to a user selecting (or tagging) a particular legacy application that they wish to migrate. At block 308, the process 300 may recommend new applications to the user. As discussed above, the recommendations may include equivalent applications, replacement applications, alternative applications, or additional applications that may be of interest to the user based on their profile, usage information, the type of legacy applications installed, any combination of the foregoing, or the like. At block 310, the process 300 may compare applications and/or display a comparison user interface (hereinafter, “UI”). In one aspect, the process 300 may compare legacy applications to potential target applications in order to make recommendations. In another aspect, the process 300 may display a comparison UI similar to that discussed above with respect to FIG. 2. For example, the comparison UI may be a comparison matrix, chart, or graph for providing an intuitive way for a user to compare mobile applications.

The process 300 may also display a VM, or a UI of a VM, to the user at block 312. As discussed above, the VM may simulate operation of target applications on target devices. At decision block 314, the process 300 may receive an indication from the user about whether they would like to acquire the target application and perform the migration. If the user decides to acquire the new device and perform the migration, the process 300 may install the target applications on the target device and/or migrate (i.e., transfer) user data and/or application data from the legacy device to the target device. In one aspect, the process 300 may install the target applications, migrate the data, and/or accept payment from the user in a one-click process. Alternatively, if the user decides not to acquire the new device at decision block 314, the process 300 may store the comparison information for a later date and subsequently send periodic notifications to the user. As discussed above, notifications may be sent based on time, availability of desired applications, or based on a relationship or frequency submitted by the user. Such periodic notifications may include updated comparison information based on then current model revisions of the target device, its system software, or its service plans.

### Illustrative Computing Environment

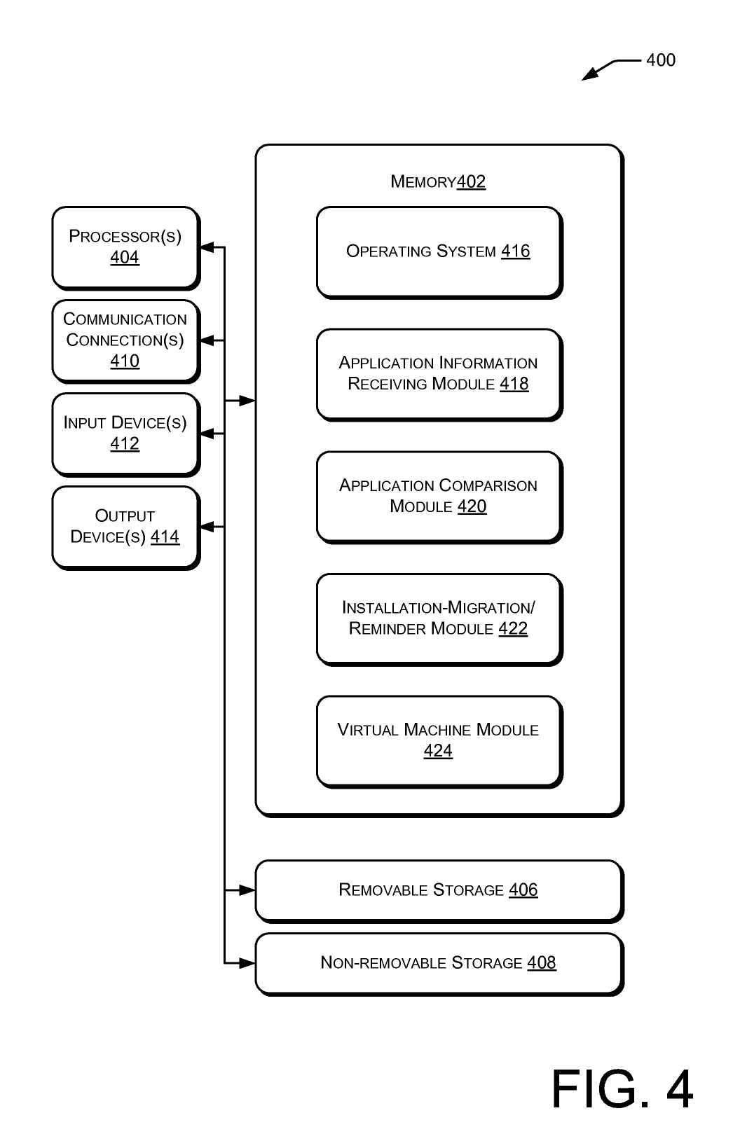

FIG. 4 provides an illustrative overview of one computing environment 400, in which aspects and features disclosed herein may be implemented. The computing environment 400 may be configured as any suitable computing device capable of implementing a mobile application migration service, and accompanying methods, such as, but not limited to those described with reference to FIGS. 1-3. By way of example and not limitation, suitable computing devices may include personal computers (PCs), servers, server farms, datacenters, or any other device capable of storing and executing all or part of the migration service.

In one illustrative configuration, the computing environment 400 comprises at least a memory 402 and one or more processing units (or processor(s)) 404. The processor(s) 404 may be implemented as appropriate in hardware, software, firmware, or combinations thereof. Software or firmware implementations of the processor(s) 404 may include computer-executable or machine-executable instructions written in any suitable programming language to perform the various functions described.

Memory 402 may store program instructions that are loadable and executable on the processor(s) 404, as well as data generated during the execution of these programs. Depending on the configuration and type of computing device, memory 402 may be volatile (such as random access memory (RAM)) and/or non-volatile (such as read-only memory (ROM), flash memory, etc.). The computing device or server may also include additional removable storage 406 and/or non-removable storage 408 including, but not limited to, magnetic storage, optical disks, and/or tape storage. The disk drives and their associated computer-readable media may provide non-volatile storage of computer readable instructions, data structures, program modules, and other data for the computing devices. In some implementations, the memory 402 may include multiple different types of memory, such as static random access memory (SRAM), dynamic random access memory (DRAM), or ROM.

Memory 402, removable storage 406, and non-removable storage 408 are all examples of computer-readable storage media. Computer-readable storage media includes, but is not limited to, volatile and non-volatile, removable and non-removable media implemented in any method or technology for storage of information such as computer-readable instructions, data structures, program modules or other data. Memory 402, removable storage 406, and non-removable storage 408 are all examples of computer storage media. Additional types of computer storage media that may be present include, but are not limited to, phase change memory (PRAM), SRAM, DRAM, other types of RAM, ROM, electrically erasable programmable read-only memory (EEPROM), flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can be accessed by the server or other computing device. Combinations of any of the above may also be included within the scope of computer-readable storage media.

The computing environment 400 may also contain communications connection(s) 410 that allow the computing environment 400 to communicate with a stored database, another computing device or server, user terminals, and/or other devices on a network. The computing environment 400 may also include input device(s) 412 such as a keyboard, mouse, pen, voice input device, touch input device, etc., and output device(s) 414, such as a display, speakers, printer, etc.

Turning to the contents of the memory 402 in more detail, the memory 402 may include an operating system 416 and one or more application programs or services for implementing a mobile application migration service including an application information receiving module 418. The application information receiving module may be configured to receive information about what mobile applications that are installed on a legacy mobile device of a user. The application information receiving module 418 may receive the information from the legacy device, a user of the legacy device, associated application stores, any combination of the foregoing, or the like.

The memory 402 may further include an application comparison module 420. The application comparison module 420 may be configured to compare legacy applications installed on a legacy device with target applications that may be available on new or different mobile devices. Similar to that discussed above, the application comparison module 420 may be configured to display a comparison matrix or other UI to the user for visually comparing information received from a multitude of resources.

Additionally, the memory 402 may also include an installation-migration/reminder module 422 for installing target applications, migrating user and/or application data, and/or sending reminders to the user about potential upgrade opportunities. In one aspect, the installation-migration/reminder module 422 may be configured to determine whether a user has decided to upgrade to a new mobile device. If so, the installation-migration/reminder module 422 may be configured to install the target applications onto the target device and/or migrate the user/application data. Alternatively, if the user decides not to acquire the new device, the installation-migration/reminder module 422 may be configured to send reminders to the user about potential upgrade opportunities.

The memory 402 may further include a virtual machine (VM) module 424. The VM module 424 may be configured to simulate operation of the target application on target devices. Generally, the VM module 424 will provide the simulations to a user interested in a potential mobile device upgrade prior to that user making a decision. In one aspect, the VM module 424 may aid the user in making such a decision by allowing the user to test out the upgraded device with their personal data migrated thereon.

Illustrative methods and systems of mobile application migration are described above. Some or all of these systems and methods may, but need not, be implemented at least partially by an architecture such as that shown in FIG. 4.

### CONCLUSION

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

What is claimed is:

1. A computer-implemented method comprising:
performed by one or more processors executing computer-readable instructions:
receiving information about an application installed on a device;
determining usage information about the application;
receiving a request for information regarding a new device;
determining an application available for the new device;
comparing the application installed on the device with the application available on the new device; and
installing one or more applications on the new device and migrating user data to the new device when an instruction to proceed with acquiring the new device is received, otherwise storing at least one of the received information, the determined usage information, the determined application available on the new device, and/or the comparison in a computer-readable memory.

2. The computer-implemented method of claim 1, wherein the device is a cellular telephone or other mobile device.

3. The computer-implemented method of claim 1, wherein the information about the application installed on the device is received manually.

4. The computer-implemented method of claim 1, wherein the information about the application installed on the device is received from a server that provided the application to the device.

5. The computer-implemented method of claim 1, wherein the information about the application installed on the device is compiled by the device without user input.

6. The computer-implemented method of claim 1, wherein the usage information is determined based at least in part on usage data compiled by the device.

7. The computer-implemented method of claim 1, wherein receiving the request for information regarding the new device comprises receiving the request in response to querying a user of the device and/or in response to ranking the application against other applications installed on the device based at least in part on the usage information of the application and usage information of the other applications installed on the device.

8. The computer-implemented method of claim 1, further comprising:
recommending a new application to be installed on the new device based at least in part on the determined usage information and/or the received request for information; or
receiving user reviews and basing the recommendation at least in part on the determined usage information, the received request for information, and/or the received user reviews.

9. The computer-implemented method of claim 1, wherein comparing the application installed on the device with the application available on the new device comprises displaying a comparison user interface (UI) to a user of the device.

10. The computer-implemented method of claim 9, wherein the comparison UI comprises a sortable chart that includes the application installed on the device and/or the application available for the new device.

11. The computer-implemented method of claim 9, wherein the comparison UI comprises information provided by independent software vendors about the application available on the new device.

12. The computer-implemented method of claim 9, wherein the comparison UI displays a new functional capability of the application available on the new device and/or a new version of the application stored on the device associated with using, on the new device, the application available on the new device.

13. The computer-implemented method of claim 1, further comprising displaying a virtual machine that simulates running the application available on the new device.

14. The computer-implemented method of claim 1, further comprising sending a notification to a user that the application is available on a new device based at least in part on the stored received information, the stored determined usage information, the stored determined application available on the new device, and/or the stored comparison.

15. One or more computer-readable storage media storing computer-executable instructions that, when executed by a processor, perform acts comprising:
receiving an indication that an application is installed on a device;
determining whether a different version of the application and/or a different application is available on a different device;
comparing the application with the different version of the application and/or the different application and storing results of the comparison in a computer-readable memory;
simulating the different version of the application and/or the different application on the different device when it is determined that the different version of the application and/or the different application are available for the different device; and
installing the different version of the application and/or the different application on the different device when an instruction to acquire the different device is received.

16. The one or more computer-readable storage media of claim 15, wherein receiving the indication that an application is installed on a device comprises receiving the indication in response to querying a user of the device, querying an application provider, and/or querying the device.

17. The one or more computer-readable storage media of claim 15, wherein determining whether the different version of the application and/or a different application is available on a different device comprises recommending the different version of the application and/or the different application based at least in part on usage information about the application, a ranking of applications, and/or a user review of the different version of the application and/or the different application.

18. The one or more computer-readable storage media of claim 15, wherein comparing the application with the different version of the application and/or the different application comprises displaying information associated with the application, the different version of the application and/or the different application.

19. A system comprising:
memory and one or more processors;
an application information receiving module, stored in the memory and executable on the one or more processors, configured to receive information associated with an application installed on a device;
an application comparison module, stored in the memory and executable on the one or more processors, configured to compare the application installed on the device with a different application available on a different device and to store the comparison in the memory; and
an installation-migration/reminder module, stored in the memory and executable on the one or more processors, configured to migrate data from the device to the different device, install the different application on the different device, and/or transmit an availability notification based at least in part on the stored comparison.

20. The system of claim 19, further comprising:
a virtual machine module, stored in the memory and executable on the one or more processors, configured to emulate running the application and/or the different application on the different device.
